(19) United States
(12) Patent Application Publication
(10) Pub. No.: US 2025/0006141 A1
(43) Pub. Date: Jan. 2, 2025

(54) DISPLAY DEVICE AND DISPLAY DRIVING METHOD

(71) Applicants: BEIJING BOE DISPLAY TECHNOLOGY CO., LTD., Beijing (CN); BOE TECHNOLOGY GROUP CO., LTD., Beijing (CN)

(72) Inventors: Changjia Fu, Beijing (CN); Dan Li, Beijing (CN); Haijun Shi, Beijing (CN); Bochang Wang, Beijing (CN); Wei Zhong, Beijing (CN); Qingshan Qu, Beijing (CN); Hongbo Feng, Beijing (CN)

(73) Assignees: BEIJING BOE DISPLAY TECHNOLOGY CO., LTD., Beijing (CN); BOE TECHNOLOGY GROUP CO., LTD., Beijing (CN)

(21) Appl. No.: 18/578,065

(22) PCT Filed: Oct. 31, 2022
(86) PCT No.: PCT/CN2022/128703

§ 371 Date: Jan. 10, 2024

(51) Int. Cl. G09G 3/34

(52) U.S. Cl. CPC G09G 3/3426; G09G 3/3413; G09G 2300/026; G09G 2300/0452; G09G 2300/0842; G09G 2320/0242; G09G 2320/0271; G09G 2320/066

(57) ABSTRACT

A display device and a display driving method are provided. In a display module, sub-pixels of a same color in adjacent rows are arranged in a staggered manner. The method includes: pre-storing a correspondence between a position of a sub-pixel in a bright-dark boundary region and a corresponding target gray-scale value, wherein a distance between the bright-dark boundary region and a boundary line of bright and dark pixels is within a predefined threshold, the bright and dark pixels are adjacent sub-pixels whose initial gray-scale difference is greater than a first predetermined gray-scale difference, and the correspondence is that the closer the position of the sub-pixel is to the boundary line of the bright and dark pixels, the lower the target gray-scale value is; and determining a current gray-scale value of the sub-pixel in the bright-dark boundary region according to the pre-stored correspondence.

### TECHNICAL FIELD

The present disclosure relates to the technical field of displaying, and in particular, to a display device and a display driving method.

### BACKGROUND

There is a jaggy phenomenon at boundary of a display region of a display module, which affects a user experience. With the development of display technology, narrow frame and ultra-narrow frame display modules are more and more widely used. In the related art, pixels at the boundary of the display region are blocked by a blocking member such as a frame or a black matrix to improve the display quality, but this is disadvantageous for designing the narrow frame or ultra-narrow frame display module.

### SUMMARY

The embodiments of the present disclosure provide a display device and a display driving method capable of improving the edge jaggy phenomenon of a display image and facilitating the realization of a narrow frame design.

The technical solutions provided by the embodiments of the present disclosure are as follows.

In a first aspect, the present disclosure provides a display driving method for driving display of a display module, wherein the display module includes a pixel array, each pixel unit in the pixel array includes at least two sub-pixels of different colors, and sub-pixels of a same color in adjacent rows are arranged in a staggered manner, wherein the method includes:
pre-storing a correspondence between a position of a sub-pixel in a bright-dark boundary region and a corresponding target gray-scale value, wherein a distance between the bright-dark boundary region and a boundary line of bright and dark pixels is within a predefined threshold, the bright and dark pixels are adjacent sub-pixels whose initial gray-scale difference is greater than a first predetermined gray-scale difference ΔL1, and the correspondence is configured as that in a direction from the boundary line of the bright and dark pixels to the sub-pixel whose initial gray-scale value is larger in the two adjacent sub-pixels, the closer the position of the sub-pixel is to the boundary line of the bright and dark pixels, the lower the target gray-scale value is;
determining a current gray-scale value of the sub-pixel in the bright-dark boundary region according to the pre-stored correspondence, and converting the current gray-scale value into a corresponding display signal, to drive the display module to display a corresponding image.

In an embodiment of the present disclosure, the correspondence is specifically configured as:
in the direction from the boundary line of the bright and dark pixels to the sub-pixel whose initial gray-scale value is larger in the two adjacent sub-pixels, the sub-pixels in the bright-dark boundary region are divided into N groups at a predetermined interval, wherein N is an integer greater than 1, and the predetermined interval is an integer multiple of a length of one sub-pixel in a row direction or an integer multiple of a width of one sub-pixel in the row direction; and in the direction from the boundary line of the bright and dark pixels to the sub-pixel whose initial gray-scale value is larger in the two adjacent sub-pixels, target gray-scale values of the N groups of sub-pixels gradually vary from a lowest target gray-scale value L0 to a highest target gray-scale value Lh at a second predetermined gray-scale difference ΔL2, and the second predetermined gray-scale difference ΔL2 is (Lh−L0)/N.

In an embodiment of the present disclosure, the at least two sub-pixels of different colors include a red sub-pixel, a green sub-pixel, and a blue sub-pixel;
the determining the current gray-scale value of the sub-pixel in the bright-dark boundary region according to the pre-stored correspondence includes:
determining current gray-scale values of the sub-pixels of all colors in the bright-dark boundary region according to the pre-stored correspondence; or
determining a current gray-scale value of the green sub-pixel in the bright-dark boundary region according to the pre-stored correspondence, wherein target gray-scale values of the red sub-pixel and the blue sub-pixel in the bright-dark boundary region are initial gray-scale values of the red sub-pixel and the blue sub-pixel in the bright-dark boundary region.

In an embodiment of the present disclosure, before the pre-storing the correspondence between the position of the sub-pixel in the bright-dark boundary region and the corresponding target gray-scale value, the method further includes:
identifying initial gray-scale values of sub-pixels in a current image;
identifying, according to the initial gray-scale values, two adjacent sub-pixels to determine the boundary line of the bright and dark pixels, wherein a difference of the initial gray-scale values of the two adjacent sub-pixels is greater than a pre-set difference; and
determining the bright-dark boundary region according to the predefined threshold

The present disclosure further provides a display device, including:
a display module, configured to display a corresponding image according to a display signal, wherein the display module includes a pixel array, each pixel unit in the pixel array includes at least two sub-pixels of different colors, and sub-pixels of a same color in adjacent rows are arranged in a staggered manner; and
a processor, including:
a storage module, configured to pre-store a correspondence between a position of a sub-pixel in a bright-dark boundary region and a corresponding target gray-scale value, wherein a distance between the bright-dark boundary region and a boundary line of bright and dark pixels is within a predefined threshold, the bright and dark pixels are adjacent sub-pixels whose initial gray-scale difference is greater than a first predetermined gray-scale difference ΔL1, and the correspondence is configured as that in a direction from the boundary line of the bright and dark pixels to the sub-pixel whose initial gray-scale value is larger in the two adjacent sub-pixels, the closer the position of the sub-pixel is to the boundary line of the bright and dark pixels, the lower the target gray-scale value is;
a control module, configured to determine a current gray-scale value of the sub-pixel in the bright-dark boundary region according to the pre-stored correspondence, and convert the current gray-scale value into a corresponding display signal, to drive the display module to display a corresponding image.

In an embodiment of the present disclosure, the correspondence stored in the storage module is specifically configured as:
in a direction from an edge of the display module to a middle area of the display module, the sub-pixels in the bright-dark boundary region are divided into N groups at a predetermined interval, wherein N is an integer greater than 1, and the predetermined interval is an integer multiple of a length of one sub-pixel in a row direction or an integer multiple of a width of one sub-pixel in the row direction; and in the direction from the edge of the display module to the middle area of the display module, target gray-scale values of the N groups of sub-pixels gradually vary from a lowest target gray-scale value L0 to a highest target gray-scale value Lh at a second predetermined gray-scale difference ΔL2, and the second predetermined gray-scale difference ΔL2 is (Lh−L0)/N.

In an embodiment of the present disclosure, the control module is specifically configured to:
determine current gray-scale values of the sub-pixels of all colors in the bright-dark boundary region according to the pre-stored correspondence; or
determine a current gray-scale value of a green sub-pixel in the bright-dark boundary region according to the pre-stored correspondence, wherein target gray-scale values of a red sub-pixel and a blue sub-pixel in the bright-dark boundary region are initial gray-scale values of the red sub-pixel and the blue sub-pixel in the bright-dark boundary region.

In an embodiment of the present disclosure, the processor further includes:
an identification module, configured to identify initial gray-scale values of sub-pixels in a current image;
a first determination module, configured to identify, according to the initial gray-scale values, two adjacent sub-pixels, to determine the boundary line of the bright and dark pixels, wherein a difference of the initial gray-scale values of the two adjacent sub-pixels is greater than a pre-set difference; and
a second determination module, configured to determine the bright-dark boundary region according to the predefined threshold.

In an embodiment of the present disclosure, the display device further includes:
a polarizer, wherein a polarizer, wherein the polarizer is attached to a displaying side and/or a non-displaying side of the display module, and a distance between the polarizer and the edge of the display module is less than or equal to 0.2 mm.

In an embodiment of the present disclosure, the display device further includes a backlight source arranged at the non-displaying side of the display module, wherein the backlight source includes a frame arranged outside a periphery of the display module, wherein a space between the frame and the edge of the display module is coated with a light-shielding colloid on a side of the frame proximate to a light-emitting side of the display device, and the light-shielding colloid overlaps an edge of the polarizer on the displaying side of the display module.

In an embodiment of the present disclosure, on the side of the frame proximate to the light-emitting side of the display device, an edge of the frame is higher than a surface of a side of the polarizer on the displaying side of the display module distal to the display module.

In an embodiment of the present disclosure, a light-shielding tape is attached to an outer side of the frame, and on a side of the light-shielding tape proximate to the light-emitting side of the display device, the light-shielding tape is flush with the edge of the frame.

In an embodiment of the present disclosure, the backlight source further includes:
an optical film arranged at the non-displaying side of the display module;
a middle frame arranged at a side of the optical film distal to the display module and supported at the edge of the display module, wherein the middle frame is arranged at an inner peripheral side of the frame,
wherein the middle frame includes a support surface for supporting the display module, and a width of the support surface is less than or equal to 0.8 mm in a direction from the edge of the display module to a display region of the display module.

In an embodiment of the present disclosure, the display device includes at least two display modules, the at least two display modules are spliced, and there is a splicing seam between the two adjacent ones of the display modules;
the display device further includes a transparent cover plate, wherein the transparent cover plate is arranged at the displaying side of the display module, and a surface of a side of the transparent cover plate distal to the display module is an are surface in an edge region proximate to the splicing seam; or
the display device further includes an optical lens, wherein the optical lens has a sawtooth-like prismatic structure at a surface of a side distal to the display module at least in an edge region proximate to the splicing seam.

The embodiments of present disclosure have the following beneficial effects.

According to the display device and the display driving method provided by the embodiments of the present disclosure, the pixel arrangement structure in the display device is of a staggered arrangement, and sub-pixels of the same color in adjacent rows are arranged in a staggered manner, so that the rainbow ripple phenomenon generated by the conventional pixel arrangement at the edge of the display module due to the partial pixels at the edge of the display screen being blocked by the backlight source can be improved; at the same time, the display driving method is improved, to arrange the sub-pixels at the bright-dark boundary region, such that in the direction from the pixels at the boundary line of the bright and dark to the sub-pixels with a larger initial gray-scale value in the two adjacent sub-pixels, the closer the position of the sub-pixel is to the boundary line of the bright and dark pixels, the lower the target gray-scale value will be, so that the luminance of each of the pixels at the bright-dark boundary position is different in a gradual change manner, to form the effect of gradual transition luminance at the bright-dark boundary position of the image, thereby solving the problem of image jaggy caused by the out-of-order arrangement of pixels.

### BRIEF DESCRIPTION OF THE DRAWINGS

FIG. 1 is a schematic diagram showing pixel arrangement in the related art;

FIG. 2 is a schematic diagram showing the principle of rainbow pattern generated when an edge of an image is blocked in the related art;

FIG. 3 is a schematic diagram showing pixel arrangement in some embodiments of the present disclosure;

FIG. 4 is a schematic diagram showing the principle of preventing rainbow pattern when edges of an image are blocked in an embodiment of the present disclosure;

FIG. 5 is a schematic diagram showing pixel arrangement in some other embodiments of the present disclosure;

FIG. 6 is a schematic diagram showing pixel arrangement in some other embodiments of the present disclosure;

FIG. 7 shows a schematic diagram of three primary color mixing;

FIG. 8 is a schematic diagram showing the principle of jagged edges generated by the out-of-order arrangement of pixels when viewed at a close distance;

FIG. 9 shows a table of measured RGB luminance values of a display device in some embodiments of the present disclosure;

FIG. 10 is showing the principle of jagged edges generated by the out-of-order arrangement of pixels when viewed at a less close distance;

FIG. 11 is a schematic diagram showing a display quality of improving a jagged edge at a bright-dark boundary position by a display driving method provided by an embodiment of the present disclosure;

FIG. 12 is a schematic diagram of the principle of the minimum resolution angle of the human eye;

FIG. 13 is a calculation model of a pixel resolution distance of a display device in some embodiments of the present disclosure;

FIG. 14 is a first flowchart illustrating a display driving method in some embodiments of the present disclosure;

FIG. 15 is a second flowchart illustrating a display driving method in some embodiments of the present disclosure;

FIG. 16 is a logic diagram illustrating a display driving method in some embodiments of the present disclosure;

FIG. 17 is a logic diagram illustrating a display driving method in some other embodiments of the present disclosure;

FIG. 18 is a diagram showing a Gamma curve in a display driving method in some other embodiments of the present disclosure;

FIG. 19 is a schematic diagram showing an effect of improving a jagged edge at a bright-dark boundary position in a black-and-white grid image in a display driving method provided by another embodiment of the present disclosure, wherein the part (a) in FIG. 19 is a diagram illustrating the presence of a jagged edge at a bright-and-dark boundary position in a black-and-white grid image in the related art, and the part (b) in FIG. 19 is a diagram illustrating the improvement of a jagged edge at a bright-and-dark boundary position in a black-and-white cell image in the display driving method provided by an embodiment of the present disclosure;

FIG. 20 is a schematic diagram showing the structure of a display module in some other embodiments of the present disclosure;

FIG. 21 is a block diagram showing the structure of a display device in some other embodiments of the present disclosure;

FIG. 22 is a block diagram showing the structure of a processor in a display device in some other embodiments of the present disclosure;

FIG. 23 is a schematic diagram showing the structure of a display device in some other embodiments of the present disclosure;

FIG. 24 is a schematic diagram showing the structure at a binding side of a display device in some other embodiments of the present disclosure;

FIG. 25 is a schematic diagram showing the structure of a display device in some other embodiments of the present disclosure;

FIG. 26 is a diagram showing an optical path simulation of the display device in the embodiments shown in FIG. 25;

FIG. 27 is a schematic diagram showing the structure of a display device provided by some other embodiments of the present disclosure; and

FIG. 28 is a graph comparing image edge luminance curves of a display device in some embodiments of the present disclosure and a display device in the prior art, wherein curve a′ is the luminance curve of the display device in some embodiments of the present disclosure, curve b′ is the luminance curve of the display device in the related art, the abscissa represents a distance from an edge display region of the module, and the ordinate represents a relative luminance ratio between an edge of an image and a central area of the image.

### DETAILED DESCRIPTION

In order that the objects, technical solutions and advantages of the embodiments of the present disclosure become more apparent, a more particular description of the embodiments of the present disclosure will be rendered by reference to the appended drawings. It is to be understood that the described embodiments are part, but not all, of the disclosed embodiments. Based on the embodiments described in the present disclosure, all other embodiments obtained by a person of ordinary skill in the art without inventive effort fall within the scope of the present disclosure.

Unless defined otherwise, technical or scientific terms used in this disclosure shall have the ordinary meaning as understood by one of ordinary skill in the art to which this disclosure belongs. The terms “first”, “second”, and the like as use herein do not denote any order, quantity, or importance, but rather are used to distinguish one element from another. Likewise, terms such as “a”, “an”, or “the” do not denote a limitation of quantity, but rather denote the presence of at least one of the referenced items. The terms “comprising” or “comprises”, and the like, means that the presence of an element or item preceding the word covers the presence of the element or item listed after the word and equivalents thereof, but does not exclude other elements or items. The terms “connecting” or “connected” and the like are not limited to physical or mechanical connections, but may include electrical connections, whether direct or indirect. The terms “upper”, “lower”, “left”, “right” and the like are used only to indicate relative positional relationships that may change accordingly when the absolute position of the object being described changes.

Before describing in detail the display device and the display driving method provided by the embodiments of the present disclosure, it is necessary to describe the following related art.

In the related art, a display device mainly comprises a display module and a backlight source, and a middle frame or a black matrix in a color filter substrate may block some sub-pixels at the boundary of a display region due to the influence of the size tolerance and assembly position tolerance of components such as a frame in the backlight source.

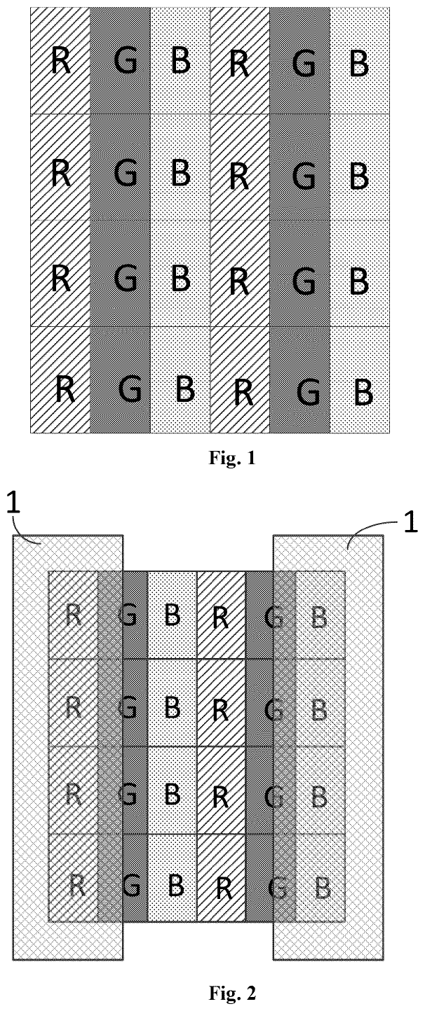

As shown in FIG. 1, in the related art, a display module adopts a conventional standard pixel arrangement manner. A blocking member 1, such as a middle frame or a black matrix, of a backlight source may partially enter a display region, and may block an entirety or a part of columns of sub-pixels of the same color at the boundary position of the display region, thereby causing uneven color mixing of RGB pixels and generating rainbow pattern. For example, in FIG. 2, a first column of R pixels and a second column of G pixels on the left side of the display module are blocked, resulting in the left side image of the display module appearing as a blue rainbow pattern; in FIG. 2, the first column of B pixels and the second column of G pixels on the right side of the display module are blocked, resulting in the image on the right side of the display module showing red rainbow pattern.

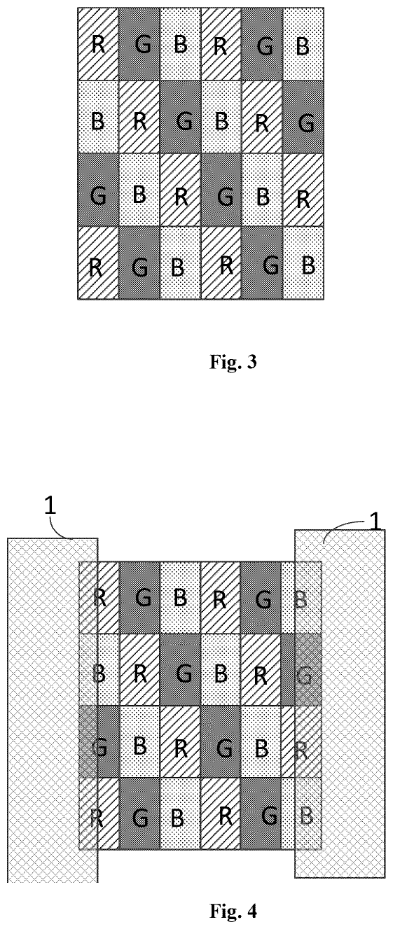

In order to solve the above-mentioned problem, referring to FIG. 3, an embodiment of the present disclosure provides a display device, wherein a pixel arrangement structure in a display module is arranged in a staggered manner, that is, the display module has a pixel array, each pixel unit in the pixel array comprises at least two sub-pixels of different colors, and the sub-pixels of the same color in adjacent rows are arranged in a staggered manner.

In such an arrangement, although an entirety of a column of or a part of sub-pixels at the boundary of the display region is blocked, each column of sub-pixels at the display region boundary is at least two sub-pixels of different colors, such as R, G and B sub-pixels, and therefore the entirety of a column of or a part of sub-pixels at the position of the boundary of the display region being not blocked may still form white light by light mixing, so that the rainbow phenomenon of the entire column does not occur, and thus improves the display region edge rainbow phenomenon.

For example, in FIG. 4, at the boundary of the display region of the display module, a first column of sub-pixels and a second column of sub-pixels are blocked, a third column of sub-pixels is not blocked or partially blocked, and the third column of sub-pixels are alternately arranged as BRG sub-pixels from top to bottom; therefore, white light is formed after the adjacent BRG sub-pixels in the third column of sub-pixels are mixed with light, and thus the image is still a white line without producing rainbow pattern.

Based on the above-mentioned pixel arrangement structure of the staggered arrangement, the display device provided in the embodiments of the present disclosure can effectively improve the rainbow pattern phenomenon at the edge of the display image.

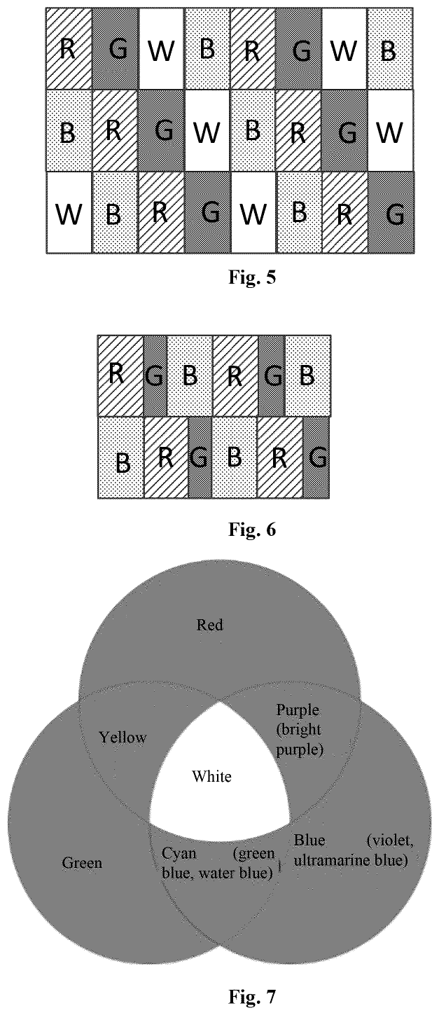

In some embodiments, as shown in FIG. 3, each pixel unit in the pixel array comprises RGB three-color sub-pixels, i.e., red, green and blue sub-pixels; in other embodiments, as shown in FIG. 4, each pixel unit in the pixel array may also comprise RGBW four-color sub-pixels, i.e., red, green, blue and white sub-pixels; in other embodiments, since the R and B luminance recognized by the human eye is much lower than the G luminance, the balance of the RGB sub-pixel luminance can be achieved by designing the sub-pixels with different sizes, as shown in FIG. 5, where the size of the G sub-pixel is smaller than the size of the R or B sub-pixel.

The inventors of the present disclosure have further studied and found that if only the pixel arrangement structure is designed such that the pixels are arranged in an out-of-order manner, the phenomenon of rainbow pattern at the edge of the display image can be solved, but the phenomenon of jaggies at the edges of the image can occur.

The specific mechanism for generating the jagged edge is analyzed as follows.

In the case of viewing an image at a short distance, for example, within 1 meter of the viewing distance, the causes of jaggies are analyzed as follows.

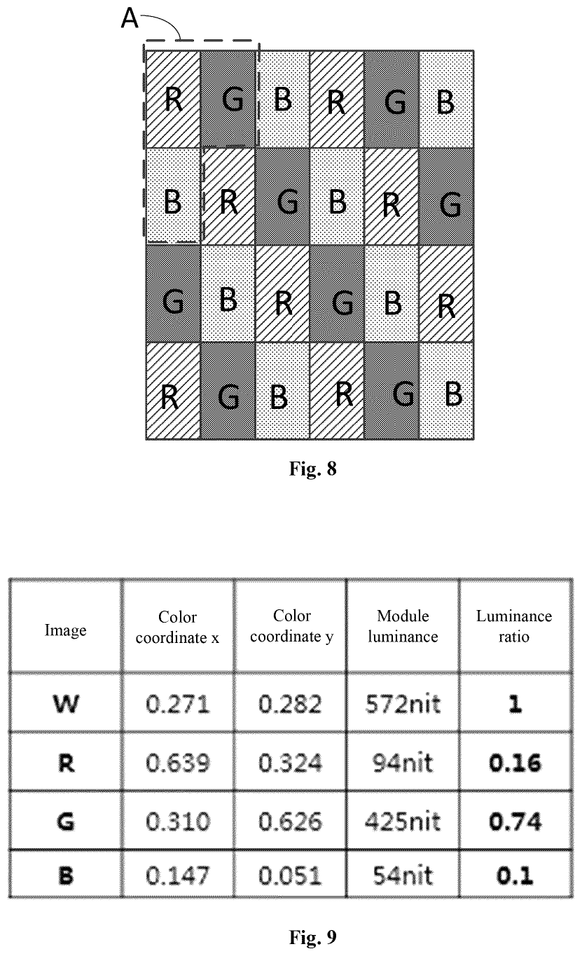

Observing the edge image effect of the display module at a short distance, the color of the image edge is poor. FIG. 8 shows that the first column on the left side is an image edge, and it can be seen from the light mixing principle of RGB three primary colors shown in FIG. 9 that the lights of the first column and the second column of B and R sub-pixels are mixed to form purple; the lights of the R and G sub-pixels are mixed to form yellow; the lights of the G and B sub-pixels mix are mixed to form cyan. It can be seen from the principle of colorimetry that white light is generally formed by mixing the three primary colors of red, green and blue according to the luminance proportion; when the luminance of red, green and blue in the light is proximate to 2:7:1, the human eye perceives pure white after the light is mixed. However, by measuring the luminance values of the RGB sub-pixels arranged in a staggered order at the edge of the image, it is obtained that the luminance ratio of the RGB sub-pixels is about 1.6:7.4:1, and it can be seen from the luminance ratio data that the luminance of the B and R sub-pixels is much lower than that of the G sub-pixel, namely, the sub-pixel with a low luminance is seen as a dark area, and the sub-pixel with a high luminance is seen as a bright area, thereby forming a sawtooth-shaped darkened area (the area shown by the dotted line frame A in FIG. 8 is a darkened area). Therefore, the luminance of R, G and B sub-pixels is uneven, and the light mixing of two adjacent sub-pixels at the edge of the image is uneven, resulting in the formation of color jaggies at the edge of the close-range image.

For the case where the screen is viewed at a long distance, for example, the viewing distance is between 1 meter and 2 meters, the cause of jaggies is analyzed as follows.

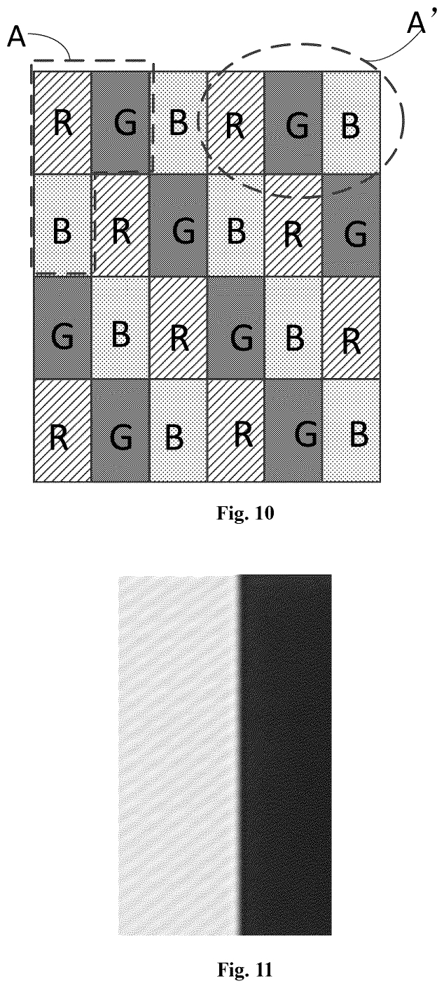

With regard to a pixel structure arranged in an staggered manner, measuring the luminance value of a RGB sub-pixels in an image, and obtaining that the luminance ratio of the RGB sub-pixels is about 1.6:7.4:1 (the luminance ratio of the RGB sub-pixels in an area shown by a dashed box A′ in the Figure is 1.6:7.4:1); all the bright points in the image are G sub-pixel positions; a dark area on the left side of the bright point is an R sub-pixel position; and a dark area on the right side is a B sub-pixel position. The reason is that the luminance of G sub-pixel is high, the luminance of R and B sub-pixels is low, and the bright area is still in the pixel area with the highest luminance after light mixing. This spaced bright-dark area is not visible to the human eye at a greater distance. It can be seen from the image edge pixel arrangement shown in FIG. 10 that the poor image edge jaggies are low luminance of the R sub-pixel and the B sub-pixel, and when viewing at a long distance, the light intensity is weak, and the human eye cannot receive the light, and therefore the R sub-pixel and the B sub-pixel are dark. Therefore, the luminance of the R, G and B sub-pixels is uneven, and the low intensity of the R and B sub-pixels at a longer distance causes a dark area to form a sawtooth phenomenon.

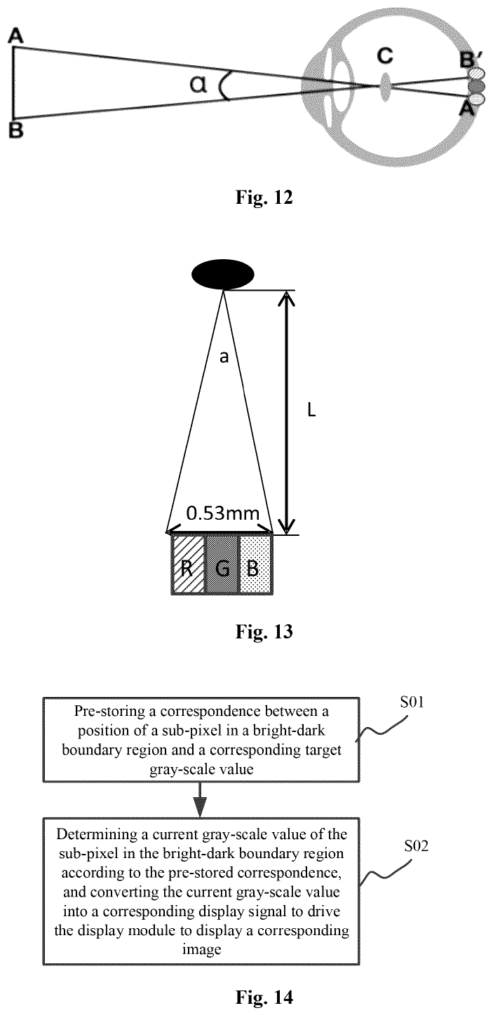

For the case of viewing an image at a long distance, for example, the viewing distance is 2 meters or more:
as shown in FIG. 11, the effect of displaying the edge image of the display module at a long distance is shown, the jaggies are not visible, and the edge image has no abnormality. FIG. 12 is a schematic diagram of the principle of the minimum resolution angle of the human eye, i.e., assuming that there are two points A and B at a distance, a certain distance between the two points is required to clearly resolve the two points, and the lower limit of the distance between the two points is related to the visual angle a of the human eye. The minimum resolution angle of human eye refers to the ability of human eye to resolve the minimum details, and the minimum angle that can be resolved: θ=1.22λ/D, where D is the diameter of the pupil and λ is the wavelength of the light source. Therefore, according to the Rayleigh criterion, if the resolution angle θ is smaller than the minimum resolution angle, the image of the object cannot be displayed. Resolution of human eye: light from an object passes through the pupil of a human eye and is transmitted onto the retina via the refractive system of the human eye. The pupil is basically a circular hole, the diameter of which is adjusted by the iris within the range of 2-8 mm; under normal luminance conditions, the diameter of the pupil is about 3 mm, the most sensitive green light wavelength of the human eye is 550 nm, and the minimum resolution angle of the human eye is about equal to 1′ (corresponding to visual acuity chart 1.0).

FIG. 13 shows a calculation model for the pixel resolution distance of the display device provided by the present disclosure, namely, tan(α/2)= (0.53/2)/L, wherein α is taken into the formula according to the resolution angle 1′ of a normal human eye, and the pixel size of the RGB of the present disclosure is 0.53 mm, thus L=1822 mm. Namely, when L>1821 mm, the human eye cannot distinguish sub-pixels, which is basically consistent with the actual observation effect. In summary, there is no abnormality in the image at a long distance, because the human eye has a limited resolution capability and cannot see the sub-pixel, and the image after three or more sub-pixels are mixed.

In the related art, in order to improve the poor display of image edges, the adopted solutions are as follows: firstly, the development cycle is long and the development cost is high by changing the distribution of the black matrix at the edge of the image to adjust the transmittance of the pixels at the border of the image, and this method can only solve the jaggy defect at the border of a certain shape, and cannot solve the problem of the arrangement of special pixels and the jaggy defect under different images; secondly, pixels with jagged edges at the border of an image are directly blocked by a black matrix or other shading structure, so as to improve the display quality, but this is not conducive to a narrow framing design, especially for a display device such as a mosaic screen, and a seamless mosaic effect cannot be achieved.

In order to improve the above-mentioned problem of poor jaggy at the image edge, in the embodiments of the present disclosure, in combination with the above-mentioned mechanism of producing poor jaggy at the image edge of the pixel arrangement structure arranged in a staggered sequence, the display driving method is improved, and it is possible to eliminate the need for a special design of a black matrix and no special requirements for the shape of an image boundary, etc., and to eliminate the need for blocking an image boundary, which is more advantageous for a narrow border design, in particular, a borderless design can be achieved to achieve a seamless splicing effect, and at the same time, the image adjustment is more flexible.

As shown in FIG. 14, an embodiment of the present disclosure provides a display driving method for driving display of a display module; wherein the display module includes a pixel array, each pixel unit in the pixel array comprises at least two sub-pixels of different colors, and sub-pixels of a same color in adjacent rows are arranged in a staggered manner; the method comprises:
step S01, pre-storing a correspondence between a position of a sub-pixel in a bright-dark boundary region and a corresponding target gray-scale value, wherein the bright-dark boundary region is configured to be a region with a distance from a boundary line of bright and dark pixels within a predefined threshold, bright and dark pixels are adjacent sub-pixels with an initial gray-scale difference being greater than a first predetermined gray-scale difference ΔL1, and the correspondence is configured as that in a direction from the boundary line of the bright and dark pixels to a sub-pixel with a larger initial gray-scale value in the two adjacent sub-pixels, the closer the position of the sub-pixel is to the boundary line of the bright and dark pixels, the lower the target gray-scale value is; and
step S02, determining a current gray-scale value of the sub-pixel in the bright-dark boundary region according to the pre-stored correspondence, and converting the current gray-scale value into a corresponding display signal to drive the display module to display a corresponding image.

In the above-mentioned method, during display driving, it arranges the sub-pixels at the bright-dark boundary region, such that in the direction from the boundary line of the bright and dark pixels to the sub-pixels with a larger initial gray-scale value in the two adjacent sub-pixels, the closer the position of the sub-pixels is to the boundary line of the bright and dark pixels, the lower the target gray-scale value will be, so that the luminance of each of the pixels at the bright-dark boundary position is different in a gradual change manner, to form the effect of gradual transition luminance at the bright-dark boundary position of the image, thereby solving the problem of image jaggy caused by the out-of-order arrangement of pixels and improving the user experience.

By this display driving method, compared with the related art in which the shape of the black matrix at the image boundary is changed to change the sub-pixel transmittance and the image boundary is blocked, it is not necessary for the design of the shape and feature arrangement of the black matrix, the production cost can be saved, the production process can be simplified, the development cycle can be shortened, and at the same time, the space for adjustment can be more flexible, and the screen with different image and different shape can be adjusted. In addition, the screen can be adjusted without blocking the image boundary, which is more conducive to the design with a narrow frame or even without a frame.

The following is a more detailed description for the display driving method of the present disclosure.

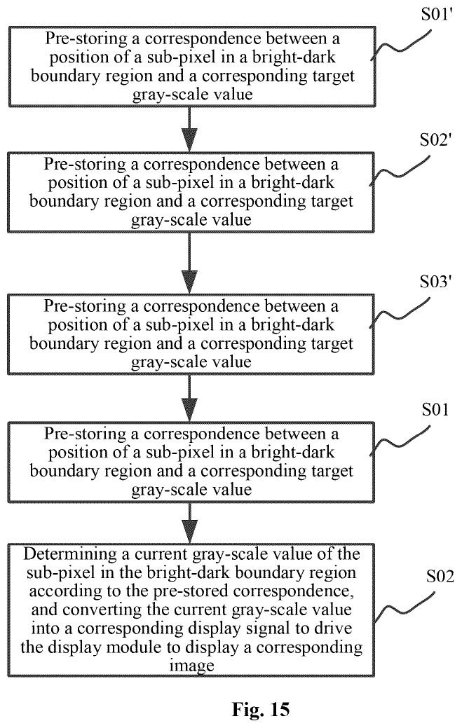

Before the step S01, as shown in FIG. 15, the method further includes:
step S01′, identifying initial gray-scale values of sub-pixels in a current image;
step S02′, identifying, according to the initial gray-scale values, two adjacent sub-pixels to determine the boundary line of the bright and dark pixels, wherein a difference of the initial gray-scale values of the two adjacent sub-pixels is greater than a pre-set difference; and
step S03′, determining the bright-dark boundary region according to the predefined threshold.

Specifically, the step S01′ specifically includes:
step S011′, setting a Gamma curve so as to set a correspondence between a pixel gray-scale value and a display luminance;
wherein the pixel gray-scale value represents a hierarchical level of different luminance between the brightest and darkest displayed, and the pixel gray-scale value facilitates the control of the display luminance via a driving voltage. For example, each pixel unit comprises a RGB sub-pixel, and by adjusting the gray-scale value of the RGB three sub-pixels corresponding to each pixel unit, the color and luminance displayed by the three sub-pixels corresponding to the pixel unit can be changed. The gamma curve is a curve that reflects the change in luminance for each gray-scale value. The abscissa of the gamma curve is the gray-scale and the ordinate is the luminance ratio.

The specific setting method of gamma curve can be as follows: it obtains the penetration rate corresponding to each gray-scale value according to the gamma curve; it obtains a gray scale corresponding to a gamma voltage according to different gray-scale values, then obtains a transmittance corresponding to a specific gray-scale value, and determines a voltage value corresponding to each transmittance. Specifically, the V-T curve of the display module is used to find the voltage closest to the corresponding transmittance as the corresponding gamma voltage.

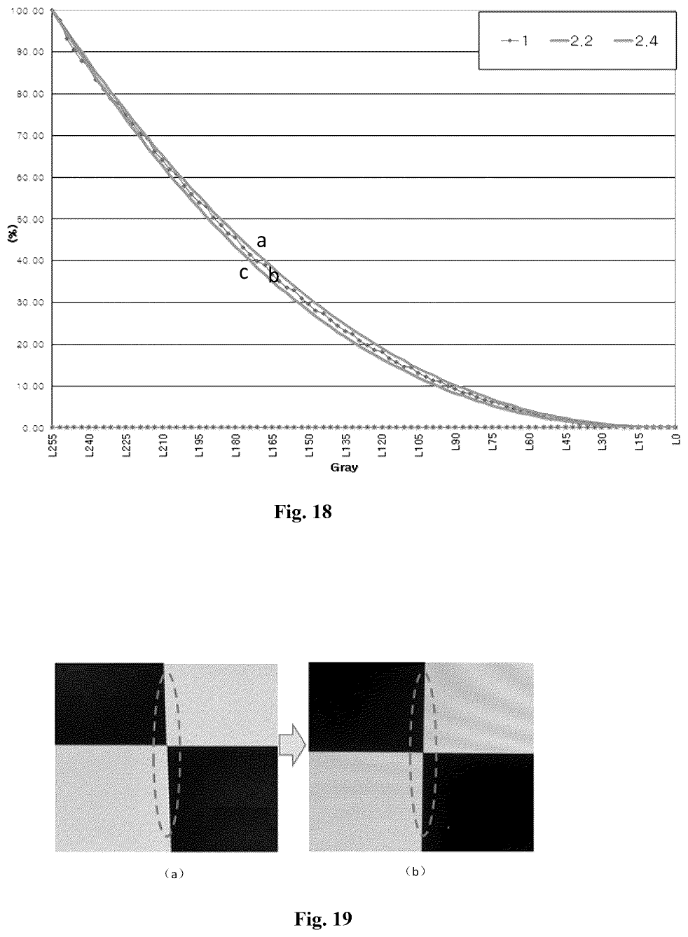

FIG. 18 shows a gamma curve of a display module in some embodiments of the present disclosure, and according to the gamma curve, a correspondence between luminance and a gray-scale value of the display module can be reflected, wherein an abscissa is a gray-scale value, an ordinate is a luminance ratio, and the entirety of the gamma curve smoothly transits. At low gray scale, the curve changes slowly. At high gray scale, the curve changes more steeply. The gamma value may be set as 2.2±0.2, in which curve a is the curve when the gamma value is equal to 2.2, and curve b is the curve when the gamma value is equal to 2.4. The point-broken curve c is a curve actually set by the display module in an embodiment of the present disclosure, and the gamma value may be between 2.2-2.4.

Step S012′, identifying a display image to identify an initial gray-scale value of a sub-pixel in the current image.

In this step, all the sub-pixels in the display image are scanned row by row and column by column, and when the display module receives a certain frame of digital image to be displayed, an initial gray-scale value corresponding to the sub-pixel is acquired by parsing and identifying the sub-pixels in the digital image. Taking a certain sub-pixel as an example, when a thin film transistor of the sub-pixel is turned on, a Source IC (power supply driving IC) outputs a driving voltage VD of corresponding grey scale and transmits same to a pixel electrode of the sub-pixel, and the driving voltage VD on the pixel electrode forms a voltage difference with a common electrode voltage VCOM, so as to control the deflection angle of liquid crystal molecules, thereby achieving luminance control of the sub-pixels. The larger the drive voltage of the sub-pixels, the larger the gray-scale value and the higher the luminance. The above-mentioned scanning process and pixel grey scale identification process can be performed synchronously, and a sub-pixel drive voltage assignment which can identify a gray-scale value for each frame of image in a drive IC (T-con IC) which stores a gamma curve in advance, namely, after a gray-scale value of a certain sub-pixel is scanned, a voltage value corresponding to the sub-pixel can be directly assigned.

Step S013′, identifying, according to the initial gray-scale values, two adjacent sub-pixels to determine the boundary line of the bright and dark pixels, wherein a difference of the initial gray-scale values of the two adjacent sub-pixels is greater than a pre-set difference.

In this step, two adjacent sub-pixels with an initial gray-scale difference being greater than a first predetermined gray-scale difference ΔL1 are identified, and a sub-pixel with a higher luminance in the adjacent sub-pixels with the gray-scale difference being greater than ΔL1 is set as a boundary reference of a bright-dark boundary region which needs to perform grey scale adjustment.

Note that in the above-mentioned scheme, the predetermined gray-scale difference may be a range of gray-scale differences of bright and dark pixels defined according to actual product requirements. For example, the first predetermined gray-scale difference ΔL1 may be the gray scale of 200, and when the gray-scale difference of adjacent sub-pixels reaches the gray scale of 200, a sub-pixel with a high luminance in the adjacent sub-pixels may be taken as a boundary reference of the bright-dark boundary region, and between the adjacent sub-pixels is a bright-dark boundary of an image.

Furthermore, in an embodiment of the present disclosure, the correspondence is specifically configured as: in the direction from the boundary line of the bright and dark pixels to the sub-pixel whose initial gray-scale value is larger in the two adjacent sub-pixels, sub-pixels in the bright-dark boundary region are divided into N groups at a predetermined interval, N being an integer greater than 1, and the predetermined interval being an integer multiple of a length of a sub-pixel in a row direction or an integer multiple of a width of a sub-pixel in the row direction; and in the direction from the boundary line of the bright and dark pixels to the sub-pixel whose initial gray-scale value is larger in the two adjacent sub-pixels, target gray-scale values of the N groups of sub-pixels gradually vary from a lowest target gray-scale value L0 to a highest target gray-scale value Lh with a second predetermined gray-scale difference ΔL2, the second predetermined gray-scale difference ΔL2 being (Lh−L0)/N.

In the above-mentioned solution, the sub-pixels in the bright-dark boundary region are divided into N groups at a predetermined interval, wherein N is an integer greater than 1, and the predetermined interval is an integer multiple of the length of one sub-pixel in the row direction or an integer multiple of the width of one sub-pixel in the row direction, specifically referring to that each group of sub-pixels may comprise at least one row or at least one column of sub-pixels in the direction from the boundary reference of the bright-dark boundary region to a sub-pixel with a larger initial gray-scale value in the two adjacent sub-pixels, and the target gray-scale values of the two adjacent groups of sub-pixels gradually change by a second predetermined gray-scale difference ΔL2; so that the luminance of the bright-dark boundary region sub-pixel is uniformly transited, and the bright-dark contrast of the image boundary is reduced.

For example, in the direction from the edge of the display module to the middle area of the display module, N groups of sub-pixels are sequentially ordered as a first group, a second group, . . . , a Nth group, and the difference of the gray-scale value of two adjacent groups of sub-pixels from the first group of sub-pixels to the Nth group of sub-pixels is the second predetermined gray-scale difference ΔL2, that is to say, starting from the first group of sub-pixels, each group of sub-pixels increases the second predetermined gray-scale difference ΔL2 compared with the gray-scale value of the previous group of sub-pixels until the gray-scale value of the Nth group of sub-pixels increases to the brightest gray-scale value.

Note that the larger the value of N is, the finer the image transition effect is and the finer the image effect is, but the larger the value of N is, the more complex the adjustment is and the lower the adjustment efficiency is. In practice, the specific value of N may be determined according to image quality requirements. It should also be noted that the highest target gray-scale value Lh may be an initial gray-scale value of a sub-pixel with a larger initial gray-scale value in the two adjacent sub-pixels.

Further, in some embodiments, the at least two differently colored subpixels include a red subpixel, a green subpixel, and a blue subpixel; the determining a current gray-scale value of the sub-pixel in the bright-dark boundary region according to the pre-stored correspondence specifically comprises: determining target gray-scale values of sub-pixels of all colors within the bright-dark boundary region according to the pre-stored correspondence relationship. That is, in some embodiments, sub-pixels of all colors within the bright-dark boundary region may be gradually transitioned.

Specifically, by reducing the gray-scale luminance of three columns of sub-pixels in the bright-dark boundary region of a black-and-white grid image column by column, the image transition effect is improved, thereby solving the problem of image jaggy. Under a black-and-white grid image, the first column of RGB sub-pixels at the bright-dark boundary positions of the white cell and the black cell is adjusted from 255 gray scales to 93 gray scales; the second column of RGB sub-pixels is adjusted from 255 gray scales to 143 gray scales; the third column of RGB sub-pixels is adjusted from 255 gray scales to 203 gray scales.

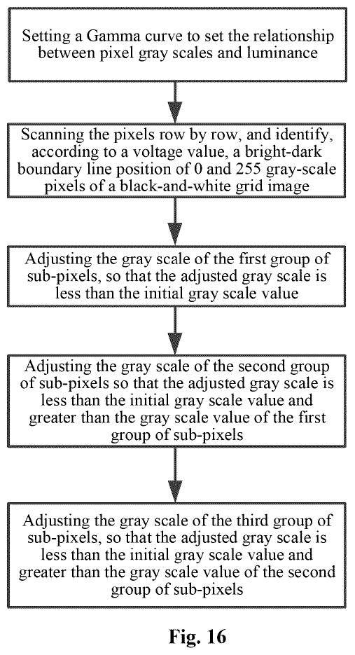

More specifically, FIG. 19 shows a logic diagram of a display driving method provided by an embodiment of the present disclosure by taking a display image as a black-and-white grid as an example. With reference to FIG. 16, the above-mentioned method may comprise the following steps.

Firstly, a Gamma curve is set to set the relationship between pixel gray scales and luminance.

Then, pixels are scanned row by row, and a bright-dark boundary line position of 0 and 255 gray-scale pixels of a black-and-white grid image is identified according to a voltage value, the 255 gray-scale pixels at the bright-dark boundary line position is taken as a reference boundary of the bright-dark boundary region, and according to a pre-stored pre-determined threshold value, an area where a sub-pixel is located within a pre-determined threshold value from the reference boundary to a distance proximate to the white grid image is taken as the bright-dark boundary region.

Then, the gray scale of the first group of sub-pixels is adjusted so that the adjusted gray scale is less than an initial gray-scale value, for example, 93; the gray scale of the second group of sub-pixels is adjusted so that the adjusted gray scale is less than the initial gray-scale value and greater than the gray-scale value of the first group of sub-pixels, for example 143; the gray scale of the third group of sub-pixels is adjusted so that the adjusted gray scale is less than the initial gray-scale value and greater than the gray-scale value of the second group of sub-pixels, for example 203, so as to complete pixel position identification and gray scale setting of the bright-dark boundary region.

In other embodiments, the determining a current gray-scale value of the sub-pixel in the bright-dark boundary region according to the pre-stored correspondence specifically comprises: according to the pre-stored correspondence, determining a current gray-scale value of a green sub-pixel in the bright-dark boundary region, and a target gray-scale value of the red sub-pixel and the blue sub-pixel in the bright-dark boundary region being an initial gray-scale value of the red sub-pixel and the blue sub-pixel in the bright-dark boundary region.

Using the above scheme, the image edge jaggies are optimized by adjusting the green sub-pixel at the bright-dark boundary.

It can be seen from the above-mentioned jaggy generation principle mechanism that the luminance of the G sub-pixel is higher than that of the R and B sub-pixels, so that a dark area is generated at the R and B pixel positions and a bright area is generated at the G pixel position, resulting in poor jaggy. Based on the above-mentioned distance, in another embodiment of the present disclosure, the gray-scale value of the N-most edge groups of G sub-pixels can be reduced, the sub-pixels at the bright-dark boundary region G are uniformly transitioned, and the luminance contrast of the R, G and B sub-pixels is not obvious, thereby improving jaggy.

It should be noted that, in this embodiment, since only the gray-scale luminance of the adjusted G sub-pixels do not change gradually, the gray-scale luminance of the R and B sub-pixels does not change gradually in comparison with the embodiment of gradually changing the gray-scale values of all the color sub-pixels in the bright-dark boundary region, in the RGB color mixing process, the mixing proportion of the three primary colors of red, green and blue according to the luminance is not satisfied, because a pure white light may not be formed, thereby generating a local color cast phenomenon. Therefore, in practical applications, image jaggies and poor color cast can be balanced in the actual adjustment process to achieve acceptable image quality effects.

Specifically, under a black-and-white grid image, the first G sub-pixel at the edge of the bright-dark boundary position of the white cell and the black cell is adjusted from 255 gray scales to 64 gray scales; the second column of G sub-pixels is adjusted from 255 gray scales to 128 gray scales; the third column of G sub-pixels is adjusted from 255 gray to 192 gray.

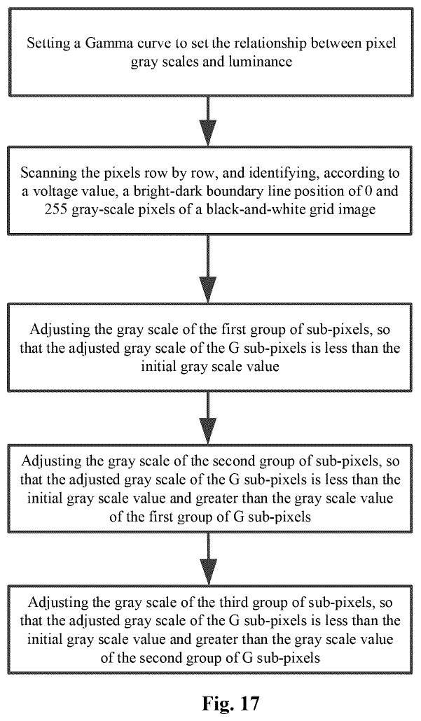

More specifically, with reference to FIG. 17, a logic diagram of a display driving method provided by an embodiment of the present disclosure, taking a display screen as a black-and-white grid as an example, may comprise the following steps.

Firstly, the Gamma curve is set to set a relationship between pixel gray scales and luminance.

Then, pixels are scanned row by row, a boundary line of bright and dark pixels position of 0 gray-scale and 255 gray-scale pixels in a black-and-white grid image are determined according to a voltage value, and the 255 gray-scale pixel at the boundary position of the bright-dark pixel is taken as a reference boundary of the bright-dark boundary region, so as to determine an area within a predefined threshold from the reference boundary in the white grid image as the bright-dark boundary region.

Then, the gray scale of the first group of G sub-pixels are adjusted so that the adjusted gray scale is less than the initial gray-scale value thereof, for example, being 64; the gray scale of the second group of G sub-pixels is adjusted so that the adjusted gray scale is less than the initial gray-scale value thereof and greater than the gray scale of the first group of G sub-pixels, for example 128; the gray scale of the third group of sub-pixels is adjusted so that the adjusted gray scale is less than the initial gray-scale value thereof and greater than the gray scale of the second group of sub-pixels, for example 192, so as to complete pixel position identification and gray scale setting of the bright-dark boundary region.

Referring to FIG. 19, the part (a) is a diagram illustrating jaggies generated at black and white cell boundaries in the display image of the prior art, and the part (b) is a diagram illustrating an effect of improving jaggies of an image by applying a display driving method according to an embodiment of the present disclosure. It can be seen from FIG. 19 that the display driving method provided by the embodiments of the present disclosure can effectively improve the image jaggy phenomenon and improve the display quality of an image.

Furthermore, in a second aspect, an embodiment of the present disclosure provides a display device. As shown in FIG. 21, the display device comprises:
a display module 100, configured to display a corresponding image according to a display signal, wherein the display module 100 has a pixel array, wherein each pixel unit in the pixel array comprises at least two sub-pixels of different colors, and sub-pixels of a same color in adjacent rows are arranged in a staggered manner; and
a processor 200, comprising:
a storage module 210, configured to pre-store a correspondence between a position of a sub-pixel in a bright-dark boundary region and a corresponding target gray-scale value, wherein the bright-dark boundary region is configured to be a region with a distance from a boundary line of bright and dark pixels within a predefined threshold, bright and dark pixels are adjacent sub-pixels with an initial gray-scale difference being greater than a first predetermined gray-scale difference ΔL1, and the correspondence is configured as that in a direction from the boundary line of the bright and dark pixels to a sub-pixel with a larger initial gray-scale value in the two adjacent sub-pixels, the closer the position of the sub-pixel is to the boundary line of the bright and dark pixels, the lower the target gray-scale value is; and
a control module 220, configured to determine a current gray-scale value of the sub-pixel in the bright-dark boundary region according to the pre-stored correspondence, and convert the current gray-scale value into a corresponding display signal to drive the display module 100 to display a corresponding image.

In the above-mentioned solution, the display device adopts staggered pixel arrangement, and at the same time, a processor 200 identifies and adjusts a pixel with a large bright-dark difference, and gradually increases the gray-scale value of a sub-pixel at a bright-dark boundary so as to gradually change the luminance of the pixel at the bright-dark boundary position, thereby improving the bright-dark contrast of the pixels at the bright-dark boundary of the image, so as to solve the problem of image jaggies. Embodiments of the present disclosure provide a display device that can eliminate the need for special shapes of a black matrix, which is flexible and fast in scheme adjustment, reduces product costs, and shortens development cycles.

In an embodiment of the present disclosure, the correspondence stored in the storage module 210 is specifically configured as:
in a direction from an edge of the display module 100 to a middle area of the display module 100, sub-pixels in the bright-dark boundary region are divided into N groups at a predetermined interval, N being an integer greater than 1, and the predetermined interval being an integer multiple of a length of a sub-pixel in a row direction or an integer multiple of a width of a sub-pixel in the row direction; and in the direction from the edge of the display module 100 to the middle area of the display module 100, target gray-scale values of the N groups of sub-pixels gradually vary from a lowest target gray-scale value L0 to a highest target gray-scale value Lh with a second predetermined gray-scale difference ΔL2, the second predetermined gray-scale difference ΔL2 being (Lh−L0)/N.

In the above-mentioned solution, the sub-pixels in the bright-dark boundary region are divided into N groups at a predetermined interval, wherein N is an integer greater than 1, and the predetermined interval is an integer multiple of the length of one sub-pixel in the row direction or an integer multiple of the width of one sub-pixel in the row direction, specifically referring to that each group of sub-pixels may comprise at least one row or at least one column of sub-pixels in the direction from the boundary reference of the bright-dark boundary region to a sub-pixel with a larger initial gray-scale value in the two adjacent sub-pixels, and the target gray-scale values of the two adjacent groups of sub-pixels gradually change by a second predetermined gray-scale difference ΔL2; so that the luminance of the bright-dark boundary region sub-pixel is uniformly transited, and the bright-dark contrast of the image boundary is reduced.

For example, in the direction from the edge of the display module 100 to the middle area of the display module 100, N groups of sub-pixels are sequentially ordered as a first group, a second group, . . . , a Nth group, and the difference of the gray-scale values of two adjacent groups of sub-pixels from the first group of sub-pixels to the Nth group of sub-pixels is the second predetermined gray-scale difference ΔL2, that is to say, starting from the first group of sub-pixels, each group of sub-pixels increases the second predetermined gray-scale difference ΔL2 compared with the gray-scale value of the previous group of sub-pixels until the gray-scale value of the Nth group of sub-pixels increases to the brightest gray-scale value.

Note that the larger the value of N is, the finer the image transition effect is and the finer the image effect is, but the larger the value of N is, the more complex the adjustment is and the lower the adjustment efficiency is. In practice, the specific value of N can be determined according to image quality requirements. It should also be noted that the highest target gray-scale value Lh may be an initial gray-scale value of a sub-pixel with a larger initial gray-scale value in the two adjacent sub-pixels.

In an embodiment of the present disclosure, the control module 220 is specifically configured to:
determine current gray-scale values of sub-pixels of all colors in the bright-dark boundary region according to the pre-stored correspondence; or
determine a current gray-scale value of the green sub-pixel in the bright-dark boundary region according to the pre-stored correspondence, with target gray-scale values of the red sub-pixel and the blue sub-pixel in the bright-dark boundary region being initial gray-scale values of the red sub-pixel and the blue sub-pixel in the bright-dark boundary region.

In the above scheme, the image edge jaggies can be optimized by adjusting the gray scales of sub-pixels of all colors in the bright-dark boundary region or only the gray scales of the green sub-pixels in the bright-dark boundary region.

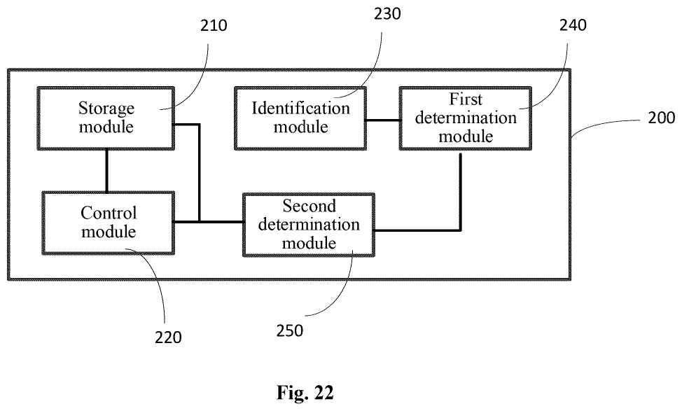

In an embodiment of the present disclosure, as shown in FIG. 22, the processor 200 further comprises:
an identification module 230, configured to identify initial gray-scale values of sub-pixels in a current image;
a first determination module 240, configured to identify, according to the initial gray-scale values, two adjacent sub-pixels to determine the boundary line of the bright and dark pixels, wherein a difference of the initial gray-scale values of the two adjacent sub-pixels is greater than a pre-set difference; and
a second determination module 250, configured to determine the bright-dark boundary region according to the predefined threshold.

In addition, the embodiments of the present disclosure provide a display device, which may mainly include a display module 100 and a backlight source 300 provided on a non-displaying side of the display module 100.

In an embodiment of the present disclosure, the backlight source 300 may include: a back plate 310, an optical film 320, a diffusion plate 330, a middle frame 340, a light-shielding tape 350, etc.

The back plate 310 may be made of common materials, including SECC, SGCC, Al, etc., and the main function thereof is to support the whole module and fix components such as a middle frame 340. In the embodiment of the present disclosure, the back plate 310 may be made of SECC, and is integrally fixed with the middle frame 340 by means of screw locking.

The optical film 320 may comprise a prism film, a diffusion film, etc., and the main function is to make the light emitted by the light source in the module more uniform and brighten.

The material of the diffusion plate 330 may comprise PS, PC, etc., mainly serving to make the light emitted by the light source in the module more uniform.

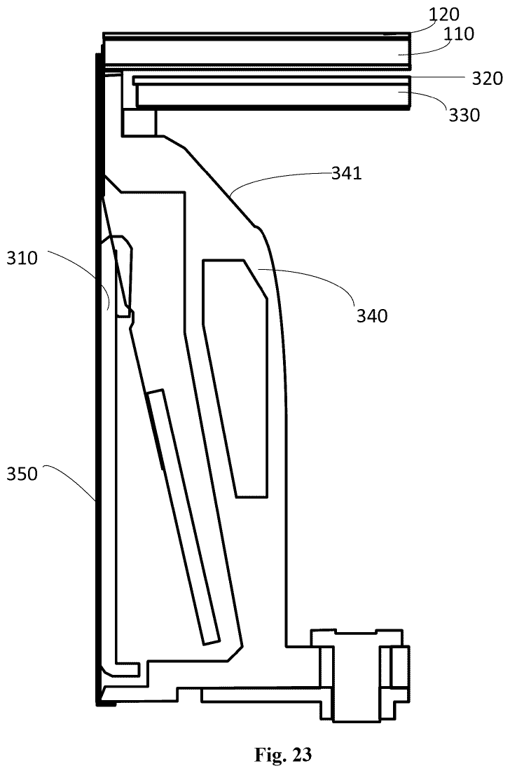

The material of the middle frame 340 comprises PC, a composite material of PC and glass fiber or Al, etc. and the main function is to support and fix a display panel via a support surface. As an example, as shown in FIG. 23, the middle frame 340 is provided with a slope 341, and the slope 341 may be provided with a reflecting surface, through which the light emitted from the light source can be reflected. By way of example, the middle frame 340 is made of aluminum, and is integrally formed by an extrusion molding die, and the support surface of the middle frame 340 and the display panel are adhered by thermosetting adhesive, so that the display panel and the middle frame 340 form an integrated structure.

The material of the light-shielding tape 350 may be selected from PET, which may be black PET adhesive tape, and is adhered to the side edge of the display panel and the outer side of the support surface of the middle frame 340, so as to avoid light in the module from penetrating at the side edge of the module and generating a light leakage phenomenon.

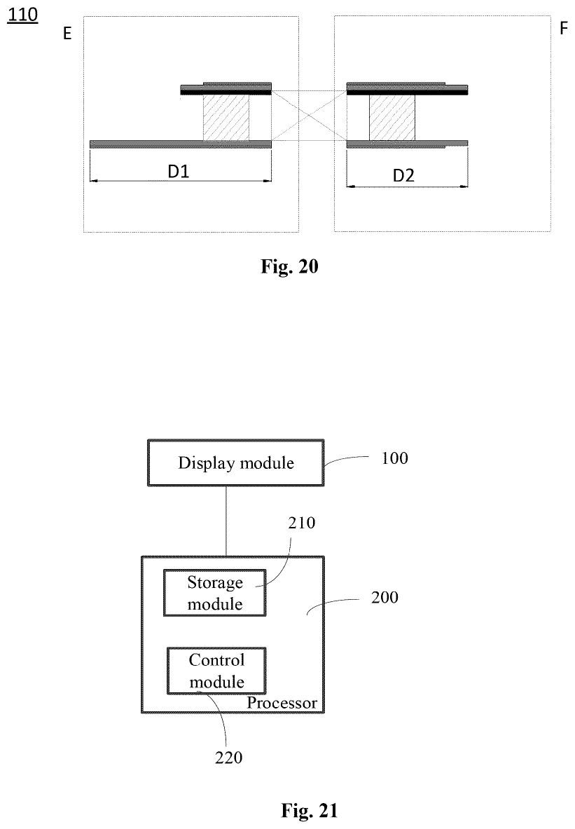

The display module 100 may include a display panel 110, a polarizer 120 attached to a displaying side and/or a non-displaying side of the display panel 110, etc. FIG. 20 is a schematic diagram showing the structure of a display module in an embodiment. As shown in FIG. 20, the display panel 110 comprises a binding side (shown by a dotted line frame E in the figure) and other sides (shown by a dotted line frame F in the figure) except the binding side, a circuit board is bound and connected to the binding side, and the frame size D1 of the binding side is greater than the frame size D2 of the other sides.

In the related art, the polarizer 120 is used in such a manner that the sheet of the polarizer 120 is adhered to the substrate of the display panel 110. Due to the dimensional tolerance of the sheet of the polarizer 120 itself and the attachment error of the attaching device, after the polarizer 120 is attached, the dimension and tolerance of the edge of the polarizer 120 from the edge of the substrate of the display panel 110 are 0.3±0.3 mm. If the light of the backlight source 300 is not directly emitted through the polarizer 120 on the side of the color filter substrate, it may cause an edge light leakage phenomenon of the polarizer 120 and affect the surrounding image quality of the display module 100.

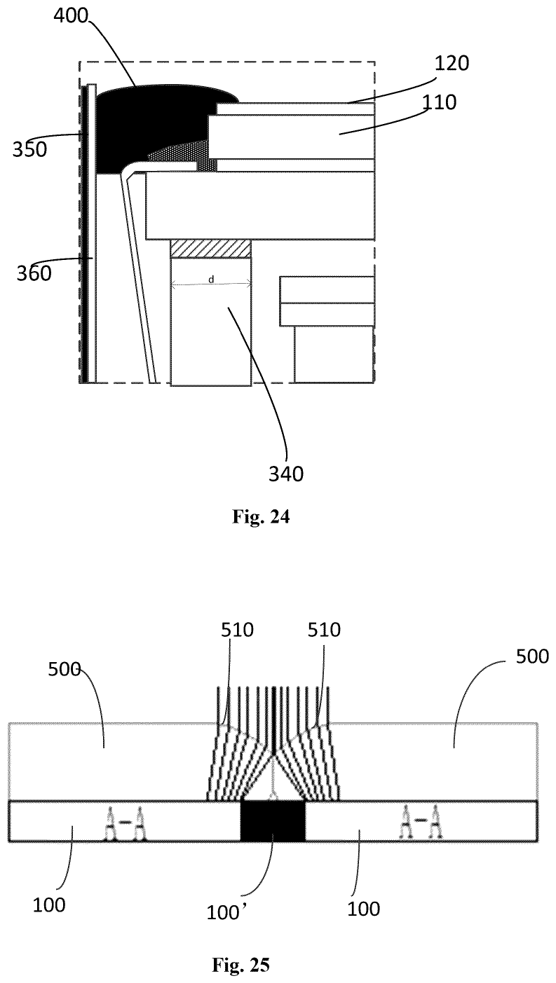

In order to improve the above problem, in the embodiment of the present disclosure, as shown in FIG. 24, the distance between the polarizer 120 and the edge of the display module 100 is less than or equal to 0.2 mm. In an embodiment of the present disclosure, the distance between the polarizer 120 and the edge of the display module 100 is 0.1±0.1 mm.

In the above-mentioned solution, a coiled material polarizer 120 may be selected as the polarizer 120, and after being adhered to the substrate of the display panel 110, a laser cutting device is used to cut off the coiled material polarizer 120; since the laser cutting device has a high accuracy and has no influence of the size tolerance of the sheet, the size and tolerance of the polarizer 120 from the edge of the substrate of the display panel 110 may be improved to be 0.1±0.1 mm, so as to avoid light rays not passing through the polarizer 120 of the color filter substrate directly, improve the light leakage phenomenon from the edge of the polarizer 120, and improve the image quality around the display module 100.

In addition, by way of example, as shown in FIG. 24, the backlight source 300 comprises a frame 360 arranged outside the periphery of the display module 100, wherein a space between the frame 360 and the edge of the display module 100 is coated with a light-shielding colloid 400 on the side proximate to the light-emitting side of the display device, and the light-shielding colloid 400 overlaps the edge of the polarizer 120 on the displaying side of the display module 100.

With the above-mentioned solution, FIG. 24 shows a structural schematic diagram of a binding side, the frame 360 is further provided outside the display panel 110 and the middle frame 340, a space between the frame 360 and the edge of the display module 100 is coated with a light-shielding colloid 400. For example, it is a black hot-melt adhesive, which overlaps with the edge of the polarizer 120, so as to further prevent the back light from the edge of the polarizer 120 from being emitted, and has a light-shielding effect, so as to solve the light leakage phenomenon at the edge of the display module 100.

In an embodiment of the present disclosure, on the side proximate to the light-emitting side of the display device, the edge of the frame 360 is higher than the side surface of the polarizer 120 on the displaying side of the display module 100 distal to the display module 100.

With the above-mentioned solution, the design height of the frame 360 is higher than the height of the polarizer 120 on the color filter substrate side of the display module 100, and the coating effect of the light-shielding colloid 400 can be further optimized to avoid the light-shielding colloid 400 flowing out of the edge of the frame 360, thus affecting the appearance effect of the module.

In addition, in the related art, a black light-shielding tape 350 is attached to the outer side of the frame 360, and the black light-shielding tape 350 may bend onto the surface of the display panel 110, and when the production line is attached manually, a phenomenon that the light-shielding tape 350 blocks the display region is easily caused, and pixels at the edge of the display panel 110 are blocked, thus affecting the image quality of the display module 100.

As shown in FIG. 24, in an embodiment of the present disclosure, a light-shielding tape 350 is adhered to the outside of the frame 360, and the light-shielding tape 350 is flush with the edge of the frame 360 on the side proximate to the light-emitting side of the display device.

With the above-mentioned solution, in the display device provided in the embodiments of the present disclosure, the light-shielding tape 350 attached to the outside of the frame 360 is not folded to the panel of the display panel 110, so that the phenomenon of pixel shading caused by the manual pasting of the light-shielding tape 350 can be avoided, and the image effect can be improved.

In addition, in the related art, the middle frame 340 serves to fix and support the display panel 110, but due to the design of the ultra-narrow frame 360, the middle frame 340 sometimes enters the display region of the display panel 110 due to dimensional tolerances and assembly tolerances, causing the light at the edge of the display panel 110 to be blocked, resulting in a dark line at the edge of the module.

In order to solve the above-mentioned problem, as an exemplary embodiment, as shown in FIG. 24, the optical film 320 in the backlight source 300 is arranged on the non-displaying side of the display module 100; the middle frame 340 is arranged at one side of the optical film 320 distal to the display module 100 and is supported at the edge of the display module 100, and the middle frame 340 is arranged at the inner peripheral side of the frame 360; wherein the middle frame 340 comprises a support surface for supporting the display module 100, and a width d of the support surface is less than or equal to 0.8 mm in a direction from an edge of the display module 100 to a display region of the display module 100.

In the above-mentioned solution, the width of the support surface of the middle frame 340 is reduced from 1.0 mm to 0.8 mm, and on the premise of satisfying the supporting function, the dark line problem caused by the edge of the display panel 110 being blocked is optimized, and the image quality of the module is improved.

In addition, as an exemplary embodiment, the display device provided by the embodiments of the present disclosure can be applied to a tiled screen due to the improved pixel arrangement, display driving method and/or module structure thereof, facilitating a 360-based design of a narrow frame. The display device may comprise at least two display modules 100, at least two of the display modules 100 are spliced, and there is a splicing seam 100′ between the two adjacent display modules 100. The splicing seam 100′ may be about 2 mm or so.

In an embodiment, as shown in FIG. 25, the display device further comprises a transparent cover plate 500, wherein the transparent cover plate 500 is arranged on the displaying side of the display module 100, and a surface of a side of the transparent cover plate 500 distal to the display module 100 is an are surface 510 in an edge region near the splicing seam 100′.

With the above-mentioned solution, the transparent cover plate 500 may be made of a transparent material such as a film or PMMA, the transparent cover plate 500 may comprise a flat area and an edge area arranged at the periphery of a screen area, the edge area is closer to the splicing seam 100′, and the edge area is designed in the shape of an arc surface 510, and the main function thereof is to use the refraction of light rays by the are surface 510 to converge the light rays emitted by the display region to the splicing seam 100′, thereby eliminating the splicing seam 100′. The protective cover plate may be adhered to the display panel 110 by means of OCA optical glue.

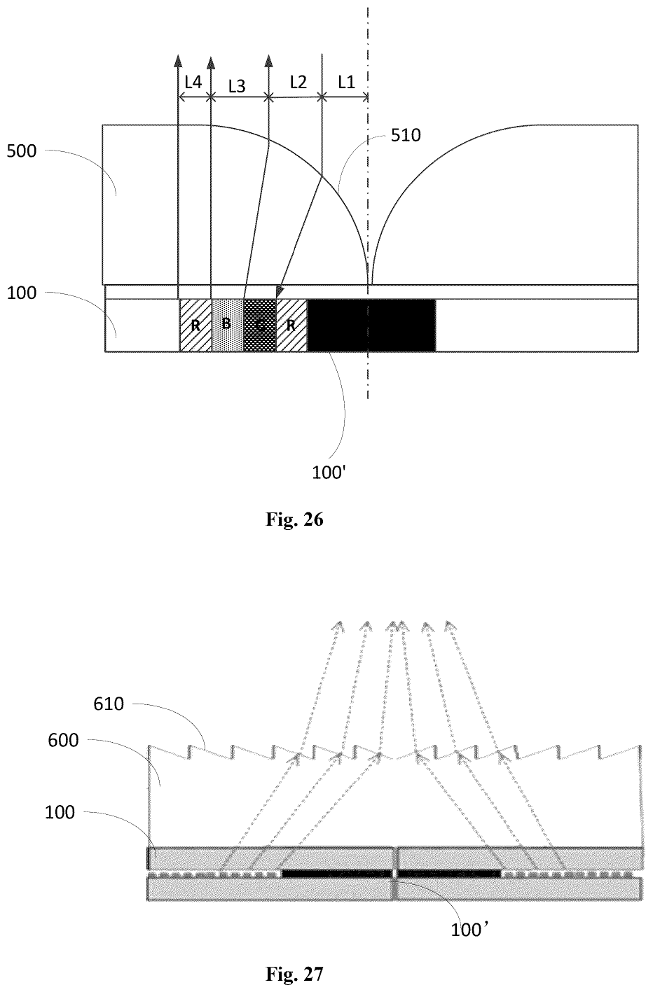

In addition, it should be noted that FIG. 26 shows an optical path simulation diagram for seamless splicing of the protective cover plate. Taking the orientation shown in FIG. 26 as an example, the display region of the display module 100 on the left side extends from the side proximate to the splicing seam 100′ to the side far away from the splicing seam 100′, and a plurality of pixel units are arranged repeatedly in sequence from right to left, wherein each pixel unit comprises an R sub-pixel, a G sub-pixel and a B sub-pixel arranged in sequence. It can be seen from the propagation path of light ray that the light ray emitted by the R sub-pixel in the first pixel unit closest to the edge position can cover the illustrated L1 area after passing through the arc surface 510 of the edge area of the protective cover plate, and by the same reasoning, the light ray emitted by the G sub-pixel in the first pixel unit can cover the illustrated L2 area after passing through the arc surface 510 of the edge area of the protective cover plate, the light ray emitted by the B sub-pixel in the first pixel unit can cover the illustrated L3 area after passing through the arc surface 510 of the edge area of the protective cover plate, and the light ray emitted by the R sub-pixel in the second pixel unit can cover the illustrated L4 area after passing through the are surface 510 of the edge area of the protective cover plate, and the lengths of L1, L2 and L3 are all greater than the lengths of the original R sub-pixel, the original G sub-pixel and the original B sub-pixel, and the length of L4 is consistent with the length of the original R sub-pixel. That is, the length of the first pixel unit RGB sub-pixel is enlarged after passing through the arc surface 510 of the protective cover plate. However, under the same distance, the human eye can easily distinguish the monochromatic sub-pixels such as red, green and blue, rather than the white pixel mixed with RGB sub-pixels. However, in the display device provided by the embodiments of the present disclosure, since the pixel arrangement is a staggered arrangement, although the pixel near the splicing seam 100′ is still enlarged, each column of adjacent pixels is not a pixel of the same color, but RGB three colors are adjacent, and thus the enlarged pixels can still mix light, forming white pixels, and a human eye does not distinguish rainbow pattern.

It can be seen therefrom that the display device provided by the embodiments of the present disclosure is based on the technical solution of the pixel staggered arrangement mode and the luminance transition display of the bright-dark boundary region, the dark line at the bright-dark boundary is improved, i.e. the luminance of the pixel at the bright-dark boundary is improved, so that after the protective cover plate is provided, and the pixel near the splicing seam 100′ is enlarged and filled to the splicing seam 100′, there is litter difference between the luminance of the pixel and other surrounding pixels, and the phenomenon that the dark line is enlarged does not occur, thereby improving the effect of the splicing seam 100′ of a seamless splicing product.

With regard to the seamless splicing effect of the display device in the related art, since the display module 100 has a dark line problem, the dark line is enlarged after the protective cover plate is provided, resulting in a poor effect of the splicing seam 100′. The seamless splicing effect of the display device of the present invention is shown in the figure, and the effect of the splicing seam 100′ is significantly improved.

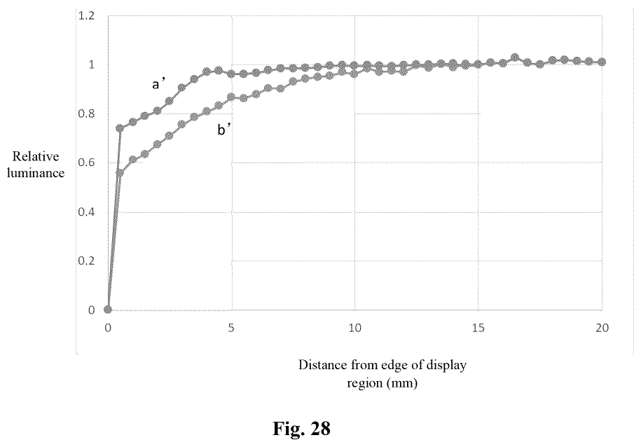

In addition, FIG. 28 is a graph comparing the edge luminance curve of the display device of the present invention with the edge luminance curve of the display module 100 in the related art, wherein the curve a′ is the edge luminance curve of the display device of the present invention, the curve b′ is the edge luminance curve of the display device in the related art, the abscissa represents the distance from the edge display region of the display module 100, and the ordinate represents the relative luminance ratio between the edge of the image and the central area of the image. It can be seen from FIG. 28 that the difference between the luminance of the periphery of the display device module and the luminance of the central area provided by the embodiments of the present disclosure is reduced, and the luminance enhancement effect is obvious.

Furthermore, in other embodiments of the present disclosure, as shown in FIG. 27, the display device further includes an optical lens 600 having a sawtooth-like prismatic structure 610 at a surface of a side distal to the display module 100 at least in an edge region near the splicing seam 100′.

With the above-mentioned solution, the optical lens 600 may be a Fresnel optical lens, and a sawtooth-shaped prism structure is arranged on the surface of one side distal to the display module 100; when the light emitted from the display panel 110 passes through the structure of the optical lens 600, the light will be refracted, converging the originally large-angle light to a position proximate to perpendicular to the direction of the display panel 110 and emitting same into the splicing seam 100′; and a human eye recognizes the light at the splicing seam 100′, thereby producing a seamless splicing effect.

The main material of the Fresnel optical lens 600 may be selected from PET or PMMA, etc. and the Fresnel optical lens 600 may be adhered to the display panel 110 by means of OCA optical glue.

The following points need to be explained.

(1) The drawings relate only to the structures to which the embodiments of the present disclosure relate, and other structures may refer to general designs.

(2) In the drawings used to describe embodiments of the present disclosure, the thickness of layers or regions is exaggerated or reduced for clarity, i.e., the drawings are not to scale. It will be understood that when an element such as a layer, film, region or substrate is referred to as being “on” or “under” another element, it can be “directly on” or “directly under” the other element or an intervening element may be present.

(3) Without conflict, embodiments of the present disclosure and features of the embodiments may be combined with each other to provide new embodiments.

The foregoing is directed to particular embodiments of the present disclosure, but the scope of the disclosure is not limited thereto, and the scope of the disclosure is defined by the appended claims.

1. A display driving method for driving a display module to display, wherein the display module comprises a pixel array, each pixel unit in the pixel array comprises at least two sub-pixels of different colors, and sub-pixels of a same color in adjacent rows are arranged in a staggered manner, wherein the method comprises:
pre-storing a correspondence between a position of a sub-pixel in a bright-dark boundary region and a corresponding target gray-scale value, wherein a distance between the bright-dark boundary region and a boundary line of bright and dark pixels is within a predefined threshold, the bright and dark pixels are adjacent sub-pixels whose initial gray-scale difference is greater than a first predetermined gray-scale difference ΔL1, and the correspondence is configured as that in a direction from the boundary line of the bright and dark pixels to the sub-pixel whose initial gray-scale value is larger in the two adjacent sub-pixels, the closer the position of the sub-pixel is to the boundary line of the bright and dark pixels, the lower the target gray-scale value is;
determining a current gray-scale value of the sub-pixel in the bright-dark boundary region according to the pre-stored correspondence, and converting the current gray-scale value into a corresponding display signal, to drive the display module to display a corresponding image.

2. The method according to claim 1, wherein the correspondence is configured as that:
in the direction from the boundary line of the bright and dark pixels to the sub-pixel whose initial gray-scale value is larger in the two adjacent sub-pixels, the sub-pixels in the bright-dark boundary region are divided into N groups at a predetermined interval, wherein N is an integer greater than 1, and the predetermined interval is an integer multiple of a length of one sub-pixel in a row direction or an integer multiple of a width of one sub-pixel in the row direction; and in the direction from the boundary line of the bright and dark pixels to the sub-pixel whose initial gray-scale value is larger in the two adjacent sub-pixels, target gray-scale values of the N groups of sub-pixels gradually vary from a lowest target gray-scale value L0 to a highest target gray-scale value Lh at a second predetermined gray-scale difference ΔL2, and the second predetermined gray-scale difference ΔL2 is (Lh−L0)/N.

3. The method according to claim 1, wherein
the at least two sub-pixels of different colors comprise a red sub-pixel, a green sub-pixel, and a blue sub-pixel;
the determining the current gray-scale value of the sub-pixel in the bright-dark boundary region according to the pre-stored correspondence comprises:
determining current gray-scale values of the sub-pixels of all colors in the bright-dark boundary region according to the pre-stored correspondence; or
determining a current gray-scale value of the green sub-pixel in the bright-dark boundary region according to the pre-stored correspondence, wherein target gray-scale values of the red sub-pixel and the blue sub-pixel in the bright-dark boundary region are initial gray-scale values of the red sub-pixel and the blue sub-pixel in the bright-dark boundary region.

4. The method according to claim 1, wherein before the pre-storing the correspondence between the position of the sub-pixel in the bright-dark boundary region and the corresponding target gray-scale value, the method further comprises:
identifying initial gray-scale values of sub-pixels in a current image;
identifying, according to the initial gray-scale values, two adjacent sub-pixels to determine the boundary line of the bright and dark pixels, wherein a difference of the initial gray-scale values of the two adjacent sub-pixels is greater than a pre-set difference; and
determining the bright-dark boundary region according to the predefined threshold.

5. A display device, comprising:
a display module, configured to display a corresponding image according to a display signal, wherein the display module comprises a pixel array, each pixel unit in the pixel array comprises at least two sub-pixels of different colors, and sub-pixels of a same color in adjacent rows are arranged in a staggered manner; and
a processor, comprising:
a storage circuit, configured to pre-store a correspondence between a position of a sub-pixel in a bright-dark boundary region and a corresponding target gray-scale value, wherein a distance between the bright-dark boundary region and a boundary line of bright and dark pixels is within a predefined threshold, the bright and dark pixels are adjacent sub-pixels whose initial gray-scale difference is greater than a first predetermined gray-scale difference ΔL1, and the correspondence is configured as that in a direction from the boundary line of the bright and dark pixels to the sub-pixel whose initial gray-scale value is larger in the two adjacent sub-pixels, the closer the position of the sub-pixel is to the boundary line of the bright and dark pixels, the lower the target gray-scale value is;
a control circuit, configured to determine a current gray-scale value of the sub-pixel in the bright-dark boundary region according to the pre-stored correspondence, and convert the current gray-scale value into a corresponding display signal, to drive the display module to display a corresponding image.

6. The display device according to claim 5, wherein
the correspondence stored in the storage circuit is configured as that:
in a direction from an edge of the display module to a middle area of the display module, the sub-pixels in the bright-dark boundary region are divided into N groups at a predetermined interval, wherein N is an integer greater than 1, and the predetermined interval is an integer multiple of a length of one sub-pixel in a row direction or an integer multiple of a width of one sub-pixel in the row direction; and in the direction from the edge of the display module to the middle area of the display module, target gray-scale values of the N groups of sub-pixels gradually vary from a lowest target gray-scale value L0 to a highest target gray-scale value Lh at a second predetermined gray-scale difference ΔL2, and the second predetermined gray-scale difference ΔL2 is (Lh−L0)/N.

7. The display device according to claim 5, wherein the control circuit is specifically configured to:
determine current gray-scale values of the sub-pixels of all colors in the bright-dark boundary region according to the pre-stored correspondence; or
determine a current gray-scale value of a green sub-pixel in the bright-dark boundary region according to the pre-stored correspondence, wherein target gray-scale values of a red sub-pixel and a blue sub-pixel in the bright-dark boundary region are initial gray-scale values of the red sub-pixel and the blue sub-pixel in the bright-dark boundary region.

8. The display device according to claim 5, wherein the processor further comprises:
an identification circuit, configured to identify initial gray-scale values of sub-pixels in a current image;
a first determination circuit, configured to identify, according to the initial gray-scale values, two adjacent sub-pixels to determine the boundary line of the bright and dark pixels, wherein a difference of the initial gray-scale values of the two adjacent sub-pixels is greater than a pre-set difference; and
a second determination circuit, configured to determine the bright-dark boundary region according to the predefined threshold.

9. The display device according to claim 5, wherein the display device further comprises:
a polarizer, wherein the polarizer is attached to a displaying side and/or a non-displaying side of the display module, and a distance between the polarizer and the edge of the display module is less than or equal to 0.2 mm.

10. The display device according to claim 9, wherein
the display device further comprises a backlight source arranged at the non-displaying side of the display module, wherein the backlight source comprises a frame arranged outside a periphery of the display module, wherein a space between the frame and the edge of the display module is coated with a light-shielding colloid on a side of the frame proximate to a light-emitting side of the display device, and the light-shielding colloid overlaps an edge of the polarizer on the displaying side of the display module.

11. The display device according to claim 10, wherein
on the side of the frame proximate to the light-emitting side of the display device, an edge of the frame is higher than a surface of a side of the polarizer on the displaying side of the display module distal to the display module.

12. The display device according to claim 11, wherein
a light-shielding tape is attached to an outer side of the frame, and on a side of the light-shielding tape proximate to the light-emitting side of the display device, the light-shielding tape is flush with the edge of the frame.

13. The display device according to claim 10, wherein the backlight source further comprises:
an optical film arranged at the non-displaying side of the display module;
a middle frame arranged at a side of the optical film distal to the display module and supported at the edge of the display module, wherein the middle frame is arranged at an inner peripheral side of the frame,
wherein the middle frame comprises a support surface for supporting the display module, and a width of the support surface is less than or equal to 0.8 mm in a direction from the edge of the display module to a display region of the display module.

14. The display device according to claim 5, wherein
the display device comprises at least two display modules, the at least two display modules are spliced, and there is a splicing seam between the two adjacent ones of the display modules;
the display device further comprises a transparent cover plate, wherein the transparent cover plate is arranged at the displaying side of the display module, and a surface of a side of the transparent cover plate distal to the display module is an arc surface in an edge region proximate to the splicing seam; or
the display device further comprises an optical lens, wherein the optical lens has a sawtooth-like prismatic structure at a surface of a side distal to the display module at least in an edge region proximate to the splicing seam.
